(19) United States
(12) Patent Application Publication
(10) Pub. No.: US 2026/0204721 A1
(43) Pub. Date: Jul. 16, 2026

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Daiji YOSHITO, Osaka (JP)

(21) Appl. No.: 19/138,104

(22) PCT Filed: Dec. 1, 2023
(86) PCT No.: PCT/JP2023/043097

§ 371 Date: Jun. 12, 2025

(30) Foreign Application Priority Data
Dec. 16, 2022 (JP) 2022-201117

(51) Int. Cl. H01M 50/298; H01M 50/503; H01M 50/507; H01M 50/514; H01M 50/55; H01M 50/569

(52) U.S. Cl. CPC H01M 50/298; H01M 50/503; H01M 50/507; H01M 50/514; H01M 50/55; H01M 50/569

(57) ABSTRACT

A wiring module includes a protector for holding busbars and a wiring member. The protector includes a first protector, a second protector adjacent to the first protector in a first direction, and a stretchable coupling portion coupling the first protector and the second protector in the first direction. The first protector includes a first stopper portion. The second protector includes a second stopper portion. The first stopper portion includes a first contact portion. The second stopper portion includes a second contact portion facing the first contact portion in the first direction and disposed closer to the first protector than the first contact portion in the first direction. The first contact portion and the second contact portion are separated by a predetermined length in the first direction when the coupling portion is in a natural state.

### TECHNICAL FIELD

The present disclosure relates to a wiring module.

### BACKGROUND

Conventionally, a wiring module used in a battery module of an electric vehicle, a hybrid vehicle or the like is known from Japanese Patent Laid-Open Publication No. 2018-174052 (Patent Document 1 below). This wiring module is provided with a plurality of busbars, a plurality of wires and an insulating protector for accommodating the plurality of busbars and the plurality of wires.

The insulating protector includes busbar accommodating portions for accommodating the busbars and wire accommodation grooves for accommodating the wires inside. The busbar accommodating portions are arranged in an arrangement direction of single batteries constituting a battery module. Two busbar accommodating portions adjacent in the arrangement direction of the single batteries are coupled by a pair of coupling portions. The pair of coupling portions respectively couple peripheral walls of the adjacent busbar accommodating portions and are curved into a U shape. In this way, the pair of coupling portions can absorb tolerances in the arrangement direction of the single batteries and various directions (height direction, a width direction of the single batteries, etc.) intersecting the arrangement direction.

### PRIOR ART DOCUMENT

### Patent Document

Patent Document 1: JP 2018-174052 A

### SUMMARY OF THE INVENTION

### Problems to be Solved

However, in the above configuration, the coupling portions are thought to be extended more than necessary, for example, in attaching the wiring module to a single battery group. That is, it is difficult to determine an upper limit of a tolerance absorption amount in the insulating protector.

### Means to Solve the Problem

The present disclosure is directed to a wiring module to be attached to a plurality of power storage elements including electrode terminals, the wiring module being provided with a plurality of busbars to be connected to the electrode terminals, a wiring member to be electrically connected to the busbars, and a protector for holding the plurality of busbars and the wiring member, the protector including a first protector, a second protector adjacent to the first protector in a first direction, the plurality of power storage elements being arranged in the first direction, and at least one stretchable coupling portion coupling the first protector and the second protector in the first direction, the first protector including at least one first stopper portion, the second protector including at least one second stopper portion, the first stopper portion including a first contact portion, the second stopper portion including a second contact portion facing the first contact portion in the first direction, the second contact portion being disposed closer to the first protector than the first contact portion in the first direction, and the first contact portion and the second contact portion being separated by a predetermined length in the first direction when the at least one coupling portion is in a natural state.

### Effect of the Invention

According to the present disclosure, it is possible to provide a wiring module capable of controlling a tolerance absorption amount in a protector.

### BRIEF DESCRIPTION OF THE DRAWINGS

FIG. 1 is a schematic diagram showing a vehicle installed with a power storage module according to an embodiment.

FIG. 2 is a plan view of the power storage module.

FIG. 3 is an enlarged plan view of the power storage module.

FIG. 4 is an enlarged perspective view of the power storage module.

FIG. 5 is an enlarged plan view of a wiring module in a state where first contact portions and second contact portions are in contact.

FIG. 6 is an enlarged perspective view of the wiring module in the state where the first and second contact portions are in contact.

FIG. 7 is a section along A-A of FIG. 5.

FIG. 8 is an enlarged perspective view of a protector.

### DETAILED DESCRIPTION TO EXECUTE THE INVENTION

### [Description of Embodiments of Present Disclosure]

First, embodiments of the present disclosure are listed and described.

(1) The wiring module of the present disclosure is to be attached to a plurality of power storage elements including electrode terminals, and provided with a plurality of busbars to be connected to the electrode terminals, a wiring member to be electrically connected to the busbars, and a protector for holding the plurality of busbars and the wiring member, the protector including a first protector, a second protector adjacent to the first protector in a first direction, the plurality of power storage elements being arranged in the first direction, and at least one stretchable coupling portion coupling the first protector and the second protector in the first direction, the first protector including at least one first stopper portion, the second protector including at least one second stopper portion, the first stopper portion including a first contact portion, the second stopper portion including a second contact portion facing the first contact portion in the first direction, the second contact portion being disposed closer to the first protector than the first contact portion in the first direction, and the first contact portion and the second contact portion being separated by a predetermined length in the first direction when the at least one coupling portion is in a natural state.

According to this configuration, it is suppressed by the contact of the first and second contact portions that the coupling portion is extended by a dimension larger than the predetermined length in the first direction.

(2) Preferably, in the wiring module of (1), the wiring member includes a first part to be held in the first protector, a second part to be held in the second protector and an intermediate portion for connecting the first part and the second part, and the intermediate portion has an extra length with the first contact portion and the second contact portion held in contact.

According to this configuration, since the intermediate portion of the wiring member has the extra length with the first and second contact portions held in contact, the breakage of the wiring member and the damage of connecting portions of the wiring member can be suppressed.

(3) Preferably, in the wiring module of (1) or (2), the first stopper portion includes a first extending portion extending toward the second protector in the first direction from an outer edge part of the first protector and the first contact portion extending in a second direction orthogonal to the first direction from the first extending portion, and the second stopper portion includes a second extending portion extending toward the first protector in the first direction from an outer edge part of the second protector and the second contact portion extending in the second direction from the second extending portion.

According to this configuration, the first and second stopper portions can be provided by a simple configuration.

(4) Preferably, in the wiring module of (3), the first protector includes two first stopper portions, one of the two first stopper portions is a third stopper portion and the other is a fourth stopper portion, the third stopper portion includes the first contact portion extending toward one side in the second direction from the first extending portion, the fourth stopper portion includes the first contact portion extending toward the other side in the second direction from the first extending portion, the second protector includes two second stopper portions, one of the two second stopper portions is a fifth stopper portion and the other is a sixth stopper portion, the fifth stopper portion includes the second contact portion extending toward the other side in the second direction from the second extending portion and facing the first contact portion of the third stopper portion in the first direction, and the sixth stopper portion includes the second contact portion extending toward the one side in the second direction from the second extending portion and facing the first contact portion of the fourth stopper portion in the first direction.

According to this configuration, since two first stopper portions (third stopper portion and fourth stopper portion) and two second stopper portions (fifth stopper portion and sixth stopper portion) are provided, it is further suppressed that the coupling portion is extended by a dimension larger than the predetermined length in the first direction.

Further, the first contact portion of the third stopper portion and that of the fourth stopper portion respectively extend in mutually opposite directions along the second direction from the first extending portions, and the second contact portion of the fifth stopper portion and that of the sixth stopper portion respectively extend in mutually opposite directions along the second direction from the second extending portions. In this way, even if the first and second protectors are shifted in the second direction, the disengagement of the first stopper portions and the second stopper portions can be suppressed.

(5) Preferably, in the wiring module of (3), the second direction is orthogonal to a plate thickness direction of the protector.

According to this configuration, the protector can be formed by pulling out a mold having a simple shape in the plate thickness direction of the protector.

(6) Preferably, in the wiring module of (1) or (2), each of the first protector and the second protector includes a busbar accommodating portion for accommodating the busbar, the busbar accommodating portion includes a bottom wall for holding the busbar thereon and a peripheral wall extending from an outer edge part of the bottom wall, the first stopper portion extends from the peripheral wall of the first protector, and the second stopper portion extends from the peripheral wall of the second protector.

According to this configuration, the first and second stopper portions can be formed to extend in a height direction or a width direction of the peripheral walls. Thus, a contact area of the first and second contact portions can be increased. Further, since a member other than the protector is not present between the busbar accommodating portions, a degree of freedom in designing the first and second stopper portions can be enhanced.

### [Details of Embodiment of Present Disclosure]

Hereinafter, an embodiment of the present disclosure is described. The present disclosure is not limited to these illustrations, but is represented by claims and intended to include all changes in the scope of claims and in the meaning and scope of equivalents.

### EMBODIMENT

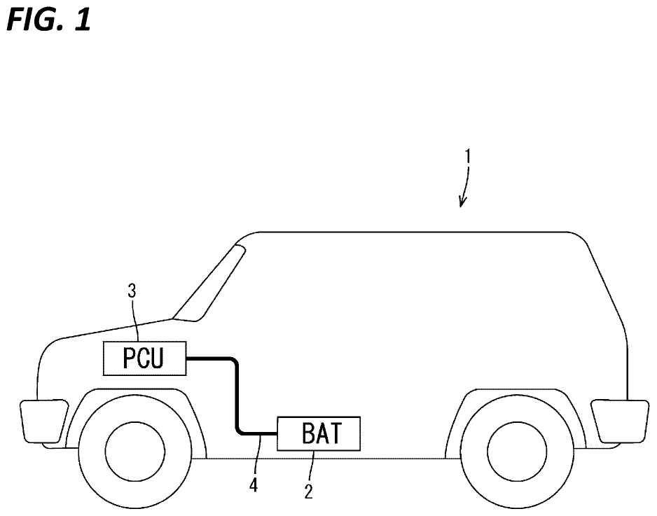

The embodiment of the present disclosure is described with reference to FIGS. 1 to 8. A power storage module 10 provided with a wiring module 20 of this embodiment is, for example, applied to a power storage pack 2 installed in a vehicle 1 as shown in FIG. 1. The power storage pack 2 is installed in the vehicle 1 such as an electric vehicle or a hybrid vehicle and used as a drive source of the vehicle 1. In the following description, for a plurality of identical members, only some members may be denoted by a reference sign and the other members may not be denoted by the reference sign.

As shown in FIG. 1, the power storage pack 2 is disposed near a center of the vehicle 1. A PCU (Power Control Unit) 3 is disposed in a front part of the vehicle 1. The power storage pack 2 and the PCU 3 are connected by a wiring harness 4. The power storage pack 2 and the wiring harness 4 are connected by an unillustrated connector. The power storage pack 2 includes the power storage module 10 provided with a plurality of power storage elements 11. In the following description, a direction indicated by an arrow Z is referred to as an upward direction, a direction indicated by an arrow X is referred to as a forward direction and a direction indicated by an arrow Y is referred to as a leftward direction except in FIG. 1.

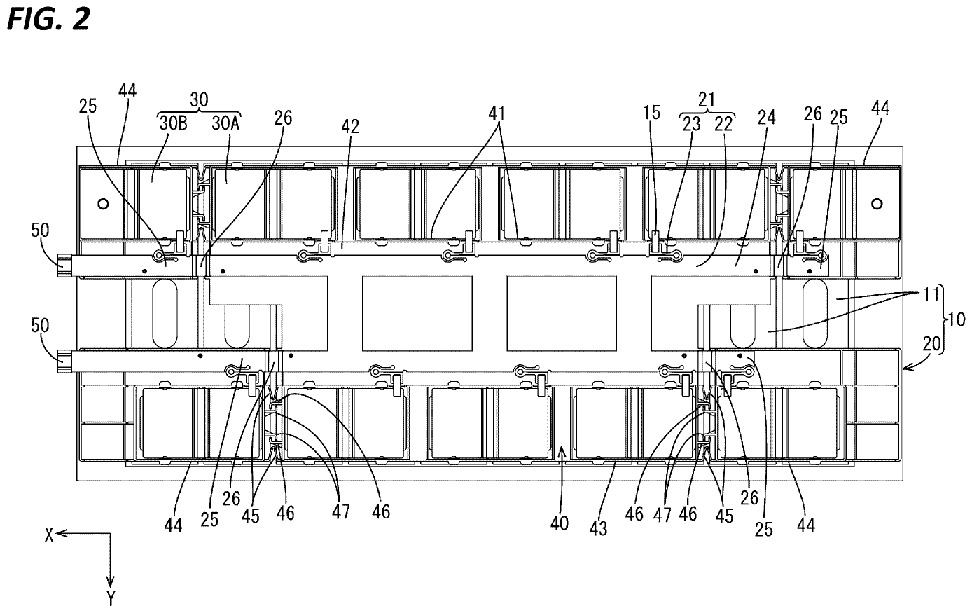

As shown in FIG. 2, the power storage module 10 is provided with the plurality of power storage elements 11 arranged in a front-rear direction (an example of a first direction) and the wiring module 20 mounted on the upper surfaces of the plurality of power storage elements 11. Unillustrated power storage components are accommodated inside the power storage element 11, and the power storage element 11 has a flat rectangular parallelepiped shape. Although not shown, the power storage element 11 includes a pair of electrode terminals at a position near a right end part of the upper surface and at a position near a left end part. One of the pair of electrode terminals is a positive electrode, and the other is a negative electrode.

### [Wiring Module]

The wiring module 20 is provided with busbars 30 to be connected to the power storage elements 11, a flexible board 21 (an example of a wiring member) to be connected to the busbars 30 and a protector 40 for holding the busbars 30 and the flexible board 21.

### [Busbars]

The busbars 30 are constituted by metal plate members and have a rectangular shape in a plan view. The busbars 30 include connection busbars 30A for connecting the electrode terminals adjacent in a stacking direction (front-rear direction) of the plurality of power storage elements 11 and output busbars 30B to be connected to the electrode terminals of the power storage elements 11 disposed in end parts in the stacking direction. The output busbar 30B connects total positive electrodes or total negative electrodes of the plurality of power storage elements 11 and an external device. The busbars 30 and the electrode terminals are connected by welding or the like. The busbars 30 are accommodated in busbar accommodating portions 41 of the protector 40 to be described later.

### [Flexible Board]

The flexible board 21 is in the form of a strip elongated in the front-rear direction as a whole. The flexible board 21 is configured by forming a plurality of voltage detection lines (not shown) on a surface of a flexible insulating sheet by a printed wiring technique. The flexible board 21 is provided with a board body 22 and extending portions 23 extending from the board body 22.

The extending portion 23 is formed to be long in the front-rear direction. The extending portion 23 is provided with a cut and configured to be stretchable. By providing the extending portion 23, an end part (tip part) of the extending portion 23 on a side opposite to the board body 22 is allowed to be displaced by a predetermined dimension with respect to the board body 22. One end (not shown) of the voltage detection line is disposed on the tip part of the extending portion 23. One end of the voltage detection line is electrically connected to the busbar 30 via a small metal piece 15.

The flexible board 21 is connected to two flexible board connectors 50 in a front end part. Terminals (not shown) are accommodated inside the connectors 50. These terminals are electrically connected to the other ends (not shown) of the voltage detection lines of the flexible board 21.

The connector 50 is connected to an external ECU (Electronic Control Unit) or the like. The ECU is configured such that a microcomputer, elements and the like are installed therein and has a known configuration provided with functions of detecting a temperature, a voltage, a current and the like of each power storage element 11 and controlling the charge/discharge of each power storage element 11.

### [First Part, Second Part, Intermediate Portion]

The flexible board 21 is provided with a first part 24, second parts 25 disposed in front of or behind the first part 24 and intermediate portions 26 connecting the first and second parts 24, 25. The first part 24, the second parts 25 and the intermediate portions 26 are continuously and integrally formed. Although described in detail later, the first part 24 is held in a first protector 43 of the protector 40. The second parts 25 are held in second protectors 44 of the protector 40. The intermediate portions 26 are disposed between the first protector 43 and the second protectors 44. In this embodiment, one first part 24, four second parts 25 and four intermediate portions 26 are provided.

### [Protector]

The protector 40 is made of insulating synthetic resin. The protector 40 is plate-like as a whole, and a plate thickness direction thereof is a vertical direction. The protector 40 is provided with the busbar accommodating portions 41 for accommodating the busbars 30 and board accommodating portions 42 for accommodating the flexible board 21. The busbar accommodating portions 41 are frame-shaped and arranged in the front-rear direction in two rows. The rows of the busbar accommodating portions 41 are disposed in left and right end parts of the protector 40. The board accommodating portions 42 extend in the front-rear direction and are disposed in a lateral central part of the protector 40.

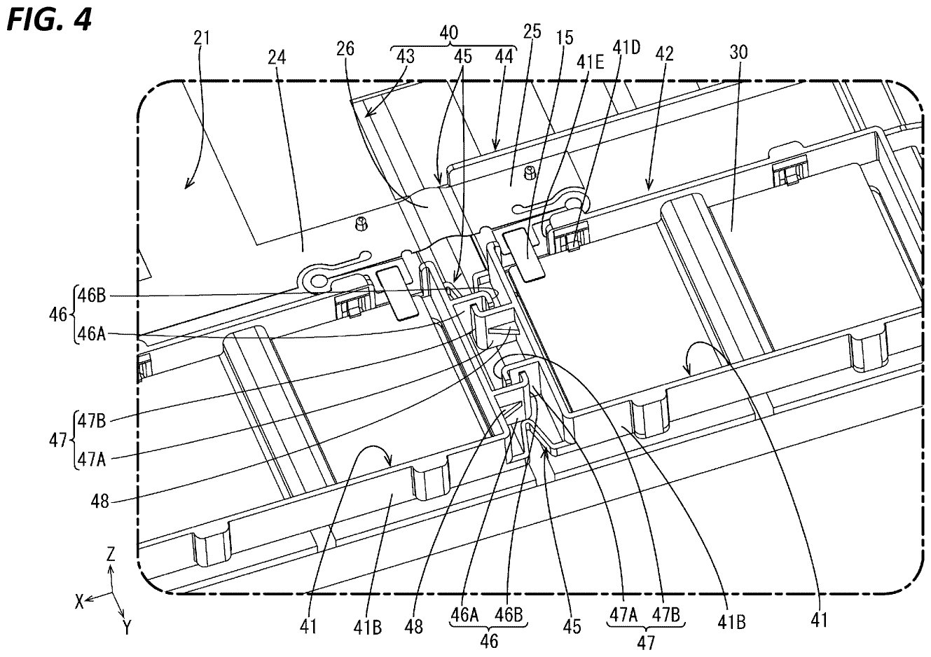

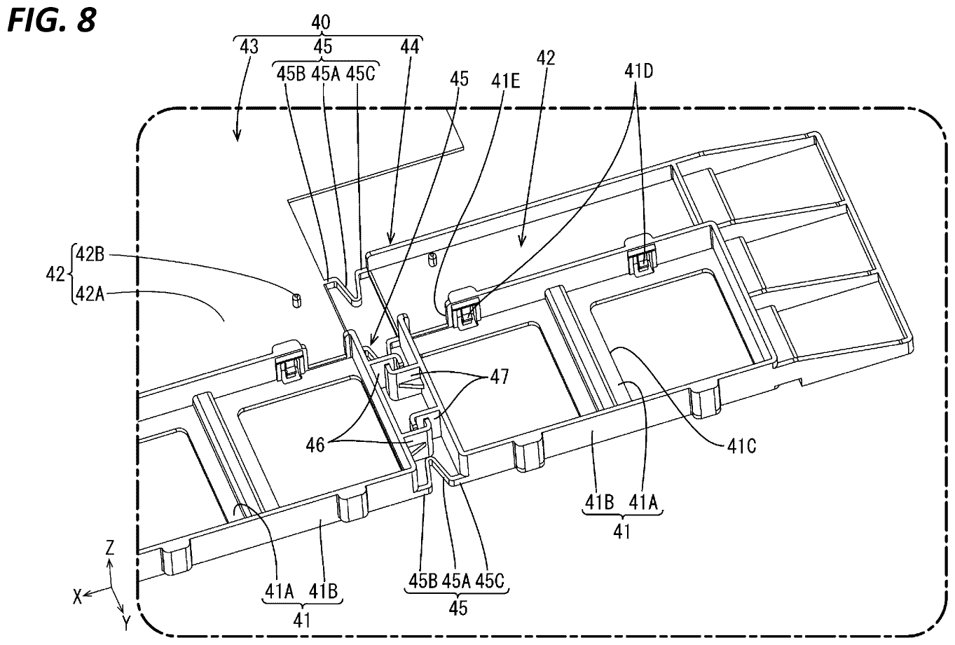

As shown in FIG. 8, the busbar accommodating portion 41 includes a bottom wall 41A having a rectangular plan view shape and a peripheral wall 41B in the form of a rectangular tube rising upward from an outer edge part of the bottom wall 41A. The bottom wall 41A is formed with connection holes 41C for connecting the electrode terminals of the power storage elements 11 and the busbars 30, the connection holes 41C penetrating in the vertical direction. As shown in FIG. 4, the peripheral wall 41B is provided with locking portions 41D for retaining the busbars 30 in the busbar accommodating portion 41. The peripheral wall 41B disposed on the side of the board accommodating portion 42 includes cut portions 41E, through which the small metal pieces 15 are inserted.

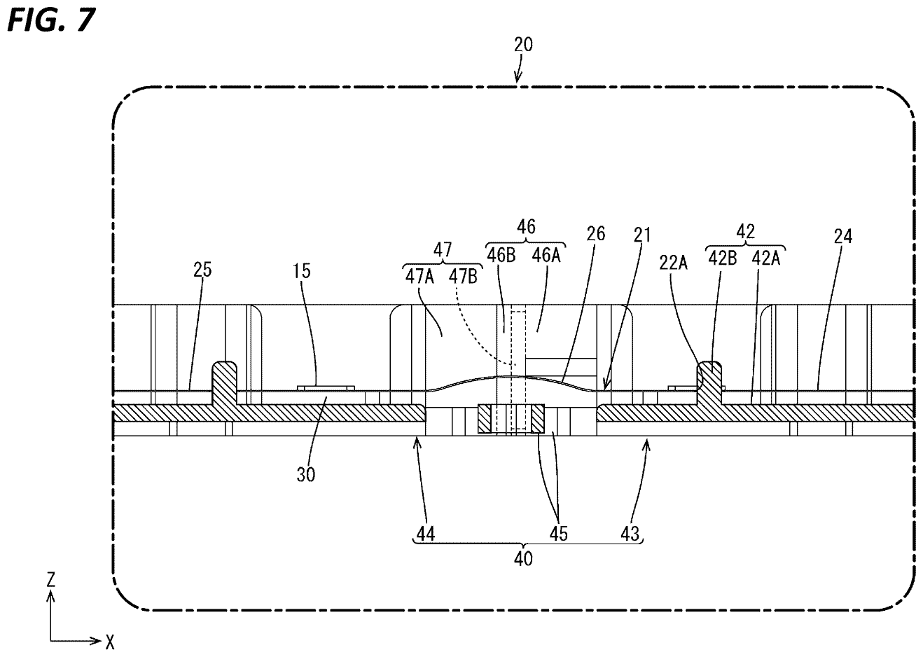

As shown in FIG. 7, the board accommodating portion 42 includes a placing surface 42A and a projection 42B projecting upward from the placing surface 42A. The flexible board 21 is placed on the placing surfaces 42A. The projections 42B are inserted into insertion holes 22A penetrating through the flexible board 21 in the vertical direction. In this way, the flexible board 21 can be held in the board accommodating portions 42.

### [First Protector, Second Protectors]

As shown in FIG. 2, the protector 40 is provided with the first protector 43, the second protectors 44 and at least one coupling portion 45 coupling the first and second protectors 43, 44 in the front-rear direction and configured to be stretchable. Manufacturing tolerances, assembly tolerances and the like of each member of the power storage module 10 can be absorbed by the coupling portion 45.

The protector 40 according to this embodiment is provided with one first protector 43, four second protectors 44 and a plurality of the coupling portions 45. The second protectors 44 are disposed in front of and behind left and right parts of the first protector 43. As shown in FIG. 8, each of the first protector 43 and the second protectors 44 includes the busbar accommodating portion 41 and the board accommodating portion 42. The board accommodating portion 42 of the first protector 43 is plate-like. The board accommodating portion 42 of the second protector 44 is in the form of a groove provided with a bottom wall and side walls rising upward from side edges of the bottom wall.

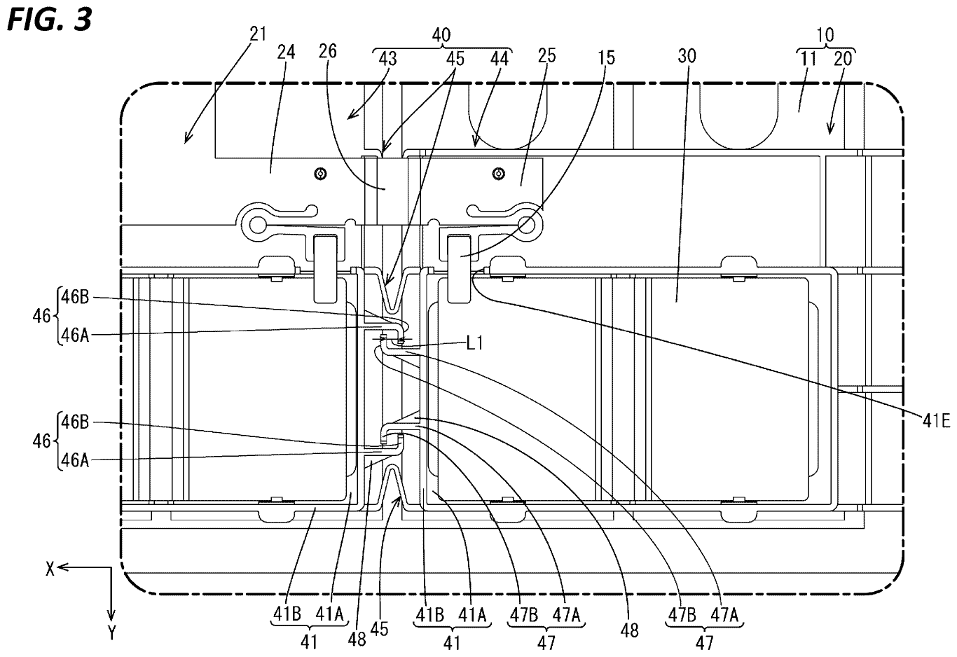

A configuration provided between the first and second protectors 43, 44 is described below with refence to FIGS. 3 to 8. Note that, in FIGS. 3 to 8, the configuration provided in a rear end part of the left part of the first protector 43 and in the second protector 44 disposed behind that rear end part is shown as a representative. Since the configurations of the second protectors 44 disposed at other positions are similar to the configuration shown in FIGS. 3 to 8, these are not described.

### [Coupling Portions]

As shown in FIG. 8, the first and second protectors 43, 44 are coupled by three coupling portions 45. That is, since the protector 40 includes one first protector 43 and four second protectors 44, the protector 40 includes a total of twelve coupling portions 45 (see FIG. 2). The coupling portion 45 includes a bent portion 45A substantially V-shaped in a plan view, a first straight portion 45B connecting one end of the bent portion 45A and the first protector 43 and a second straight portion 45C connecting the other end of the bent portion 45A and the second protector 44. The bent portion 45A is flat in the vertical direction and extends in a horizontal direction. Each straight portion 45B, 45C extends in the front-rear direction. The coupling portion 45 is configured to be resiliently deformable. A state where no stress is applied to the coupling portion 45 and the coupling portion 45 is neither contracted nor extended is called a natural state.

The three coupling portions 45 coupling the first and second protectors 43, 44 are composed of two coupling portions 45 (hereinafter, referred to as first coupling portions) coupling the busbar accommodating portion 41 of the first protector 43 and the busbar accommodating portion 41 of the second protector 44 and one coupling portion 45 (hereinafter, referred to as a second coupling portion) coupling the board accommodating portion 42 of the first protector 43 and the board accommodating portion 42 of the second protector 44. The first coupling portions connect lower end parts of corner parts of the peripheral walls 41B of the busbar accommodating portions 41. The bent portion 45A of the first coupling portion extends inwardly of the busbar accommodating portion 41 with respect to each straight portion 45B, 45C in the lateral direction. The second coupling portion couples end parts on an opposite side to the busbar accommodating portions 41 in the lateral direction of the board accommodating portions 42. The bent portion 45A of the second coupling portion extends toward the busbar accommodating portions 41 with respect to each straight portion 45B, 45C in the lateral direction.

### [First Stopper Portions, Second Stopper Portions]

The first protector 43 includes two first stopper portions 46 on the peripheral wall 41B of the busbar accommodating portion 41 on the side of the second protector 44 (rear side). The first stopper portions 46 are, for example, located within a height range of the peripheral wall 41B in the vertical direction. The second protector 44 includes two second stopper portions 47 on the peripheral wall 41B of the busbar accommodating portion 41 on the side of the first protector 43 (front side). The second stopper portions 47 are, for example, located within a height range of the peripheral wall 41B in the vertical direction. The first and second stopper portions 46, 47 are, for example, L-shaped in a plan view and arranged to be engageable with each other. Although described in detail later, the first and second stopper portions 46, 47 are members for limiting an extensible length of the coupling portions 45 in the front-rear direction by contacting each other. Note that since the first protector 43 includes two first stopper portions 46 for each second protector 44, the first protector 43 is provided with eight first stopper portions 46 as a whole (see FIG. 2).

### [First Extending Portions, First Contact Portions]

As shown in FIG. 3, each first stopper portion 46 includes a first extending portion 46A extending from the peripheral wall 41B of the first protector 43 toward the second protector 44 (rearward) and a first contact portion 46B extending in the lateral direction (an example of a second direction) from the first extending portion 46A. Two first stopper portions 46 are disposed side by side in the lateral direction. Out of the two first stopper portions 46, the first stopper portion 46 disposed on a right side is referred to as a right first stopper portion (an example of a third stopper portion) and the first stopper portion 46 disposed on a left side is referred to as a left first stopper portion (an example of a fourth straight portion) below.

### [Right First Stopper Portion, Left First Stopper Portion]

The first contact portion 46B of the right first stopper portion extends toward the left side (an example of one side in the second direction) from the first extending portion 46A of the right first stopper portion. The first contact portion 46B of the left first stopper portion extends toward the right side (an example of the other side in the second direction) from the first extending portion 46A of the left first stopper portion. That is, two first stopper portions 46 (right and left first stopper portions) include the first contact portions 46B extending in mutually opposite directions along the lateral direction from the first extending portions 46A.

### [Second Extending Portions, Second Contact Portions]

Each second stopper portion 47 includes a second extending portion 47A extending from the peripheral wall 41B of the second protector 44 toward the first protector 43 (forward) and a second contact portion 47B extending in the lateral direction from the second extending portion 47A. Two second stopper portions 47 are disposed side by side in the lateral direction. Out of the two second stopper portions 47, the second stopper portion 47 disposed on the right side is referred to as a right second stopper portion (an example of a fifth stopper portion) and the second stopper portion 47 disposed on the left side is referred to as a left second stopper portion (an example of a sixth straight portion) below.

### [Right Second Stopper Portion, Left Second Stopper Portion]

The second contact portion 47B of the right second stopper portion extends rightward from the second extending portion 47A of the right second stopper portion. The second contact portion 47B of the left second stopper portion extends leftward from the second extending portion 47A of the left second stopper portion. That is, two second stopper portions 47 (right and left second stopper portions) include the second contact portions 47B extending in mutually opposite directions along the lateral direction from the second extending portions 47A.

### [Predetermined Length]

The second contact portion 47B is facing the first contact portion 46B in the front-rear direction and disposed forward (on the side of the first protector 43) of the first contact portion 46B. If the coupling portions 45 are in the natural state, the first and second contact portions 46B, 47B are disposed apart from each other by a predetermined length L1.

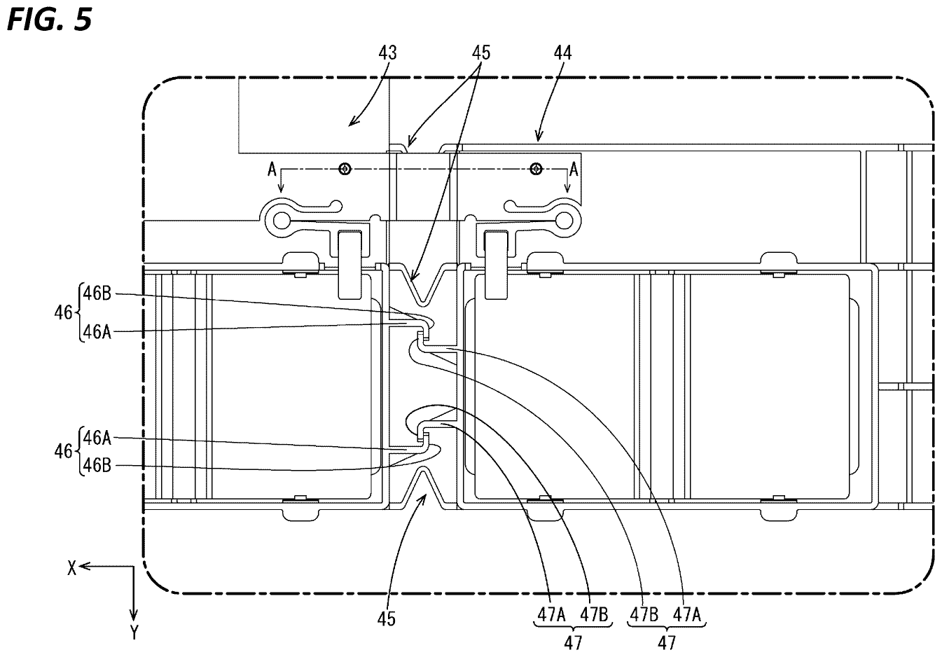

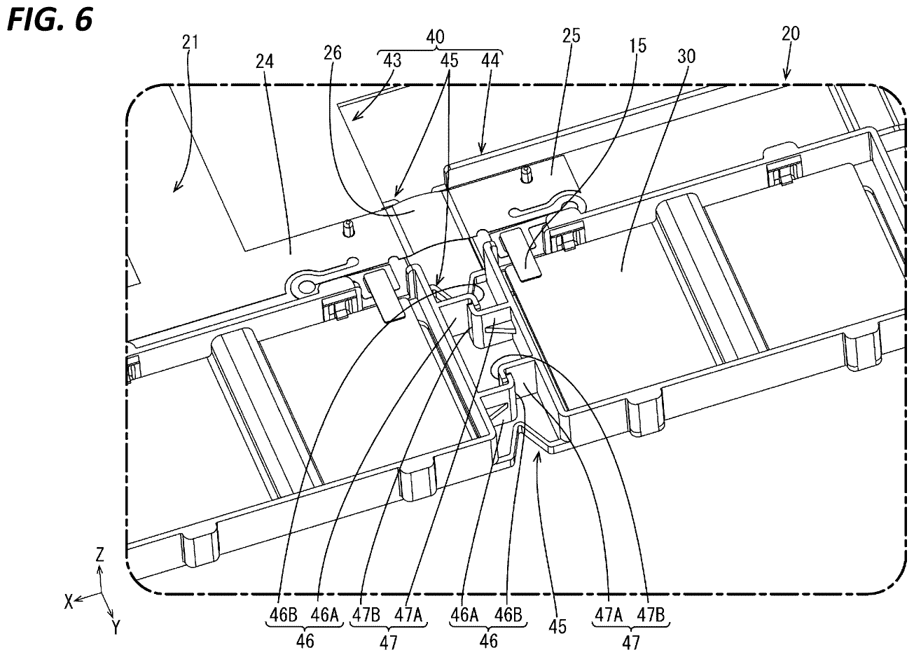

If the coupling portions 45 are deformed to extend in the front-rear direction, the first and second contact portions 46B, 47B are displaced in directions toward each other. If the coupling portions 45 are extended by the predetermined length L1 in the front-rear direction as compared to the case where the coupling portions 45 are in the natural state, the first and second contact portions 46B, 47B come into contact as shown in FIGS. 5 and 6. In this way, the extension of the coupling portions 45 beyond the predetermined length L1 as compared to the natural state is suppressed. That is, an upper limit of a tolerance absorbing amount in the coupling portions 45 can be determined.

The predetermined length L1 is preferably set to be equal to or somewhat longer than a total of tolerances in the front-rear direction required to be absorbed in the first and second protectors 43, 44.

As shown in FIGS. 6 and 7, the intermediate portion 26 of the flexible board 21 has an extra length with the first and second contact portions 46B, 47B held in contact. More particularly, a dimension in the front-rear direction of the intermediate portion 26 is set to be larger than the sum of a dimension in the front-rear direction of the coupling portions 45 in the natural state and the predetermined length L1. In this way, even if the first and second contact portions 46B, 47B contact and the coupling portions 45 are maximally (predetermined length L1) extended in the front-rear direction, the intermediate portion 26 is slackened so that no tensile stress is applied to the intermediate portion 26. Therefore, it can be suppressed that the flexible board 21 is broken due to the application of a tensile stress to the intermediate portion 26 or connecting portions of the flexible board 21 and the small metal pieces 15 are damaged.

Further, according to this embodiment, the breakage and the like of the flexible board 21 can be suppressed if the dimension in the front-rear direction of the intermediate portion 26 is even slightly larger than the sum of the dimension in the front-rear direction of the coupling portions 45 in the natural state and the predetermined length L1. On the other hand, since the upper limit of the extensible length of the coupling portions 45 is not clearly determined in a conventional configuration in which the first and second stopper portions 46, 47 are not provided, it has been necessary to set a longer extra length of the intermediate portion 26. That is, according to this configuration, the extra length of the intermediate portion 26 can be made shorter as compared to the conventional configuration, and the used amount of the flexible board 21 in the wiring module 20 can be suppressed. Therefore, the manufacturing cost of the wiring module 20 is easily reduced.

In this embodiment, as shown in FIG. 3, the two first stopper portions 46 include the first contact portions 46B extending in the mutually opposite directions from the first extending portions 46A thereof, and the two second stopper portions 47 include the second contact portions 47B extending in the mutually opposite directions from the second extending portions 47A thereof. The two second extending portions 47A are disposed inside the two first extending portions 46A in the lateral direction. According to this configuration, if the first protector 43 is shifted rightward or leftward with respect to the second protector 44, the first contact portions 46B and the second extending portions 47A contact and the second contact portions 47B and the first extending portion 46B contact. Thus, the first and second contact portions 46B, 47B can be maintained in postures facing each other in the front-rear direction. In other words, the first and second stopper portions 46, 47 can be kept in an engageable state.

On the other hand, if two first stopper portions include first contact portions extending in the same direction from first extending portions thereof and two second stopper portions include second contact portions extending in the same direction from second extending portions thereof unlike this embodiment, the first and second stopper portions may be possibly disengaged if the first protector 43 is shifted rightward or leftward with respect to the second protector 44.

In this embodiment, as shown in FIG. 4, the first and second stopper portions 46, 47 are provided to extend in the height direction (vertical direction) of the peripheral walls 41B of the busbar accommodating portions 41 and have a height equal to that of the peripheral walls 41B. According to this configuration, contact areas of the first and second contact portions 46B, 47B are easily maximized in a region occupied by the protector 40.

On the other hand, it is, for example, thought to provide first and second stopper portions between the board accommodating portions 42 unlike this embodiment. However, in this case, since the flexible board 21 (intermediate portion 26) extends between the board accommodating portions 42, there are many restrictions in designing the first and second stopper portions. Further, since the board accommodating portions 42 are flat in the vertical direction, it is difficult to make contact areas of the first and second contact portions larger.

In this embodiment, as shown in FIGS. 3 and 4, each extending portion 46A, 47A is provided with a reinforcement rib 48 on a side opposite to an extension side of each contact portion 46B, 47B from each extending portion 46A, 47A. The reinforcement rib 48 is a plate-like member flat in the vertical direction. The reinforcement rib 48 improves the strength of each extending portion 46A, 47A by connecting each extending portion 46A, 47A and the peripheral wall 41B.

### [Functions and Effects of Embodiment]

According to the embodiment, the following functions and effects are achieved.

The wiring module 20 according to the embodiment is to be attached to the plurality of power storage elements 11 including the electrode terminals and provided with the plurality of busbars 30 to be connected to the electrode terminals, the wiring member (flexible board 21) to be electrically connected to the busbars 30 and the protector 40 for holding the plurality of busbars 30 and the wiring member. The protector 40 includes the first protector 43, the second protectors 44 connected to the first protector 43 in the first direction (front-rear direction), in which the plurality of power storage elements 11 are arranged, and at least one stretchable coupling portion 45 coupling the first and second protectors 43, 44 in the first direction. The first protector 43 includes at least one first stopper portion 46, and the second protector 44 includes at least one second stopper portion 47. The first stopper portion 46 includes the first contact portion 46B, and the second stopper portion 47 includes the second contact portion 47B facing the first contact portion 46B in the first direction and to be disposed closer to the first protector 43 than the first contact portion 46B in the first direction. If the at least one coupling portion 45 is in the natural state, the first and second contact portions 46B, 47B are separated by the predetermined length L1 in the first direction.

According to this configuration, it is suppressed by the contact of the first and second contact portions 46B, 47B that the coupling portion 45 is extended by a dimension larger than the predetermined length L1 in the first direction.

In the embodiment, the wiring member includes the first part 24 to be held in the first protector 43, the second parts 25 to be held in the second protectors 44 and the intermediate portions 26 connecting the first and second parts 24, 25, and the intermediate portions 26 have the extra length with the first and second contact portions 46B, 47B held in contact.

According to this configuration, since the intermediate portions 26 of the wiring member have the extra length with the first and second contact portions 46B, 47B held in contact, the breakage of the wiring member and the damage of the connecting portions of the wiring member can be suppressed.

In the embodiment, the first stopper portion 46 includes the first extending portion 46A extending toward the second protector 44 in the first direction from the outer edge part of the first protector 43 and the first contact portion 46B extending in the second direction (lateral direction) orthogonal to the first direction from the first extending portion 46A, and the second stopper portion 47 includes the second extending portion 47A extending toward the first protector 43 in the first direction from the outer edge part of the second protector 44 and the second contact portion 47B extending in the second direction from the second extending portion 47A.

According to this configuration, the first and second stopper portions 46, 47 can be provided by a simple configuration.

In the embodiment, the first protector 43 includes two first stopper portions 46, one of the two first stopper portions 46 is the third stopper portion (right first stopper portion) and the other is the fourth stopper portion (left first stopper portion), the third stopper portion includes the first contact portion 46B extending toward one side (leftward) in the second direction from the first extending portion 46A, and the fourth stopper portion includes the first contact portion 46B extending toward the other side (rightward) in the second direction from the first extending portion 46A. The second protector 44 includes two second stopper portions 47, one of the two second stopper portions 47 is the fifth stopper portion (right second stopper portion) and the other is the sixth stopper portion (left second stopper portion), the fifth stopper portion includes the second contact portion 47B extending toward the other side in the second direction from the second extending portion 47A and facing the first contact portion 46B of the third stopper portion in the first direction, and the sixth stopper portion includes the second contact portion 47B extending toward the one side in the second direction from the second extending portion 47A and facing the first contact portion 46B of the fourth stopper portion in the first direction.

According to this configuration, since two first stopper portions 46 (third stopper portion and fourth stopper portion) and two second stopper portions (fifth stopper portion and sixth stopper portion) are provided, it can be further suppressed that the coupling portion 45 is extended by a dimension larger than the predetermined length L1 in the first direction.

Further, the first contact portion 46B of the third stopper portion and the first contact portion 46B of the fourth stopper portion respectively extend in the opposite directions along the second direction from the first extending portions 46A, and the second contact portion 47B of the fifth stopper portion and the second contact portion 47B of the sixth stopper portion respectively extend in the opposite directions along the second direction from the second extending portions 47A. In this way, even if the first and second protectors 43, 44 are shifted in the second direction, the disengagement of the first and second stopper portions 46, 47 can be suppressed.

In the embodiment, the second direction is orthogonal to the plate thickness direction (vertical direction) of the protector 40.

According to this configuration, the protector 40 can be formed by pulling out a mold having a simple shape in the plate thickness direction of the protector 40.

In the embodiment, each of the first and second protectors 43, 44 includes the busbar accommodating portion 41 for accommodating the busbars 30, and the busbar accommodating portion 41 includes the bottom wall 41A for holding the busbars 30 thereon, and the peripheral wall 41B extending from the outer edge part of the bottom wall 41A. The first stopper portion 46 extends from the peripheral wall 41B of the first protector 43, and the second stopper portion 47 extends from the peripheral wall 41B of the second protector 44.

According to this configuration, the first and second stopper portions 46, 47 can be formed to extend in the height direction or the width direction of the peripheral walls 41B. Thus, the contact area of the first and second contact portions 46B, 47B can be increased. Further, since a member other than the protector 40 is not present between the busbar accommodating portions 41, a degree of freedom in designing the first and second stopper portions 46, 47 can be enhanced.

### OTHER EMBODIMENTS

(1) Although the protector 40 includes one first protector 43, four second protectors 44 and twelve coupling portions 45 in the above embodiment, there is no limitation to this and the numbers of first protectors, second protectors and coupling portions provided in a protector may be changed as appropriate.

(2) Although two first stopper portions 46 and two second stopper portions 47 are provided between the first protector 43 and each second protector 44 in the above embodiment, there is no limitation to this and the numbers of first stopper portions and second stopper portions may be changed as appropriate.

(3) Although the first stopper portion 46 includes the first extending portion 46A and the first contact portion 46B, the second stopper portion 47 includes the second extending portion 47A and the second contact portion 47B and the first and second stopper portions 46, 47 are L-shaped in the plan view in the above embodiment, there is no limitation to this and the shapes of first and second stopper portions may be changed as appropriate.

(4) Although the second direction is orthogonal to the plate thickness direction of the protector 40 in the above embodiment, there is no limitation to this and a second direction may not be orthogonal to a plate thickness direction of a protector.

(5) Although the coupling portion 45 includes the bent portion 45A V-shaped in the plan view and is configured to be flat in the vertical direction in the above embodiment, there is no limitation to this and the shape of a coupling portion may be changed as appropriate.

(6) Although the wiring member is the flexible board 21 in the above embodiment, there is no limitation to this and a wiring member may be a wire or a wire and a flexible board.

### LIST OF REFERENCE NUMERALS

1: vehicle
2: power storage pack
3: PCU
4: wiring harness
10: power storage module
11: power storage element
15: small metal piece
20: wiring module
21: flexible board
22: board body
22A: insertion hole
23: extending portion
24: first part
25: second part
26: intermediate portion
30: busbar
30A: connection busbar
30B: output busbar
40: protector
41: busbar accommodating portion
41A: bottom wall
41B: peripheral wall
41C: connection hole
41D: locking portion
41E: cut portion
42: board accommodating portion
42A: placing surface
42B: projection
43: first protector
44: second protector
45: coupling portion
45A: bent portion
45B: first straight portion
45C: second straight portion
46: first stopper portion
46A: first extending portion
46B: first contact portion
47: second stopper portion
47A: second extending portion
47B: second contact portion
48: reinforcement rib
50: connector
L1: predetermined length

1. A wiring module to be attached to a plurality of power storage elements including electrode terminals, comprising:
a plurality of busbars to be connected to the electrode terminals;
a wiring member to be electrically connected to the busbars; and
a protector for holding the plurality of busbars and the wiring member,
the protector including a first protector, a second protector adjacent to the first protector in a first direction, the plurality of power storage elements being arranged in the first direction, and at least one stretchable coupling portion coupling the first protector and the second protector in the first direction,
the first protector including at least one first stopper portion,
the second protector including at least one second stopper portion,
the first stopper portion including a first contact portion,
the second stopper portion including a second contact portion facing the first contact portion in the first direction, the second contact portion being disposed closer to the first protector than the first contact portion in the first direction, and
the first contact portion and the second contact portion being separated by a predetermined length in the first direction when the at least one coupling portion is in a natural state.

2. The wiring module of claim 1, wherein:
the wiring member includes a first part to be held in the first protector, a second part to be held in the second protector and an intermediate portion for connecting the first part and the second part, and
the intermediate portion has an extra length with the first contact portion and the second contact portion held in contact.

3. The wiring module of claim 1 wherein:
the first stopper portion includes:
a first extending portion extending toward the second protector in the first direction from an outer edge part of the first protector; and
the first contact portion extending in a second direction orthogonal to the first direction from the first extending portion, and
the second stopper portion includes:
a second extending portion extending toward the first protector in the first direction from an outer edge part of the second protector; and
the second contact portion extending in the second direction from the second extending portion.

4. The wiring module of claim 3, wherein:
the first protector includes two first stopper portions,
one of the two first stopper portions is a third stopper portion and the other is a fourth stopper portion,
the third stopper portion includes the first contact portion extending toward one side in the second direction from the first extending portion,
the fourth stopper portion includes the first contact portion extending toward the other side in the second direction from the first extending portion,
the second protector includes two second stopper portions,
one of the two second stopper portions is a fifth stopper portion and the other is a sixth stopper portion,
the fifth stopper portion includes the second contact portion extending toward the other side in the second direction from the second extending portion and facing the first contact portion of the third stopper portion in the first direction, and
the sixth stopper portion includes the second contact portion extending toward the one side in the second direction from the second extending portion and facing the first contact portion of the fourth stopper portion in the first direction.

5. The wiring module of claim 3, wherein the second direction is orthogonal to a plate thickness direction of the protector.

6. The wiring module of claim 1 wherein:
each of the first protector and the second protector includes a busbar accommodating portion for accommodating the busbar,
the busbar accommodating portion includes a bottom wall for holding the busbar thereon and a peripheral wall extending from an outer edge part of the bottom wall,
the first stopper portion extends from the peripheral wall of the first protector, and
the second stopper portion extends from the peripheral wall of the second protector.
